(19) United States
(12) Patent Application Publication
(10) Pub. No.: US 2017/0330647 A1
(43) Pub. Date: Nov. 16, 2017

(54) Power Cable for Use with Artificial Lift Systems

(71) Applicant: Saudi Arabian Oil Company, Dhahran (SA)

(72) Inventors: Jinjiang Xiao, Dhahran (SA); Rafael Adolfo Lastra, Dhahran (SA); Brian A. Roth, Dhahran (SA)

(73) Assignee: Saudi Arabian Oil Company, Dhahran (SA)

(21) Appl. No.: 15/335,712

(22) Filed: Oct. 27, 2016

Related U.S. Application Data
(60) Provisional application No. 62/334,109, filed on May 10, 2016.

(51) Int. Cl. H01B 7/04; E21B 17/00; H01B 7/02; E21B 43/12

(52) U.S. Cl. CPC H01B 7/046; H01B 7/0216; E21B 17/003; E21B 43/128

(57) ABSTRACT

A method for providing power to an artificial lift system includes providing at least two conductors, each conductor being an insulated conductor having insulating material surrounding such conductor. The at least two conductors are surrounded with a composite fiber jacket to form a power cable, the composite fiber jacket being an outermost member of the power cable and having a substantially smooth exterior surface. The power cable is connected to the artificial lift system such that a load of the artificial lift system is transferred to the composite fiber jacket of the power cable.

### CROSS REFERENCE TO RELATED APPLICATION

This application claims priority to and the benefit of co-pending U.S. Provisional Application Ser. No. 62/334,109, filed May 10, 2016, titled “Power Cable For Use With Artificial Lift Systems,” the full disclosure of which is hereby incorporated herein by reference in its entirety for all purposes.

### BACKGROUND OF THE DISCLOSURE

### 1. Field of the Disclosure

The disclosure relates generally to artificial lift systems for subterranean wells, and more particularly to rig-less deployment of electrically driven artificial lift systems with a weight bearing power cable.

### 2. Description of the Related Art

Artificial lift systems are deployed in some hydrocarbon producing wellbores to provide artificial lift to deliver fluids to the surface. The fluids, which typically are liquids, are made up of liquid hydrocarbon and water. When installed, a typical artificial lift system is suspended in the wellbore at the bottom of a string of production tubing. In addition to a pump, artificial lift systems can include an electrically powered motor and seal section. The pumps are often one of a centrifugal pump or positive displacement pump. Alternately, artificial lift systems can include a progressive cavity pump, a wet gas compressor, or other known artificial lift system.

When the artificial lift system fails, workover rigs are used to pull out the tubing, and replace the failed artificial lift system. Workover rigs are costly, especially offshore. Also, waiting time for rigs can be as long as 6-12 months, leading to significant production deferral. Technologies are being developed to allow for rig-less deployment of artificial lift systems inside the production tubing with the power cable. When an artificial lift system fails, the artificial lift system can be pulled out, leaving production tubing in place.

Some current artificial lift systems utilize contra-helical wire wrapped power cables; however, such cables weigh over 5 lbs per foot. Cables of this weight will become problematic, and the deployment rig will require significant space to handle the power cables. In addition, sealing against such a cable presents challenges for well control equipment due to the interstices in the contra-helical wire. Splicing of such a cable can result in a cable that is too large and splicing is a time consuming process.

### SUMMARY OF THE DISCLOSURE

Embodiments disclosed herein describe systems and methods for a power cable with sufficient strength to hold its own weight, support the weight of equipment, and to additionally handle an over pull. The power cable can maintain an electrical integrity of the power cable while the power cable is exposed to fluids and gasses of a wellbore of a subterranean well. The power cable is sufficiently tough to not be damaged by installation equipment during run and pull, can resist support member corrosion damage, and can protect the electrical conductors from the harsh chemical environment of the wellbore.

In an embodiment of this disclosure, a method for providing power to an artificial lift system includes providing at least two conductors, each conductor being an insulated conductor having insulating material surrounding such conductor. The at least two conductors are surrounded with a composite fiber jacket to form a power cable, the composite fiber jacket being an outermost member of the power cable and having a substantially smooth exterior surface. The power cable is connected to the artificial lift system such that a load of the artificial lift system is transferred to the composite fiber jacket of the power cable.

In alternate embodiments, before surrounding the at least two conductors with the composite fiber jacket, the at least two conductors can be encased with a filler material. Surrounding the at least two conductors with the composite fiber jacket can include applying the composite fiber jacket directly to the filler material. The composite fiber jacket can be a flexible member and the method can further include deploying the power cable from a spool to lower the artificial lift system into a wellbore. The power cable can support the load of the artificial lift system in a range of 20,000 to 40,000 lbf.

In other alternate embodiments, surrounding the at least two conductors with the composite fiber jacket can include surrounding the at least two conductors with the composite fiber jacket that includes a synthetic fiber combined with a polymetric material or alternately the composite fiber jacket can include a material selected from a group consisting of carbon fiber, Kevlar™, Vectran™, resin, epoxy, PEEK, and combinations thereof.

In another embodiment of this disclosure, a method for providing power to an artificial lift system for producing fluids from a subterranean well includes providing at least two conductors, each conductor being an insulated conductor having insulating material surrounding such conductor. The at least two conductors can be surrounded with a composite fiber jacket to form a power cable, the composite fiber jacket being an outermost member of the power cable and having a substantially smooth exterior surface. The power cable can be connected to the artificial lift system such that a load of the artificial lift system is transferred to the composite fiber jacket of the power cable. The artificial lift system can be lowered into a wellbore with the power cable. The artificial lift system can be energized with the power cable to assist fluids within the subterranean well in being produced to a surface.

In alternate embodiments, before surrounding the at least two conductors with the composite fiber jacket, the at least two conductors can be encased with a filler material, and surrounding the at least two conductors with the composite fiber jacket can include applying the composite fiber jacket directly to the filler material. The composite fiber jacket can be a flexible member and lowering the artificial lift system into the wellbore with the power cable can include deploying the power cable from a spool. The artificial lift system can be supported within the wellbore such that the composite fiber jacket supports the load of the artificial lift system in a range of 20,000 to 40,000 lbf. The artificial lift system can be retrieved from the wellbore with the power cable.

In another alternate embodiment of this disclosure, a system for providing power to an artificial lift system includes a power cable having at least two conductors, each conductor being an insulated conductor having insulating material surrounding such conductor. A filler material encases the at least two conductors. A composite fiber jacket surrounds the filler material, the composite fiber jacket being an outermost member of the power cable and having a substantially smooth exterior surface.

In alternate embodiments, a connecting member can secure an end of the power cable to the artificial lift system. The connecting member can be oriented to transfer a load of the artificial lift system to the composite fiber jacket of the power cable. The composite fiber jacket can be a flexible member operable to retain an integrity of the composite fiber jacket when deployed from a spool. The composite fiber jacket can include a synthetic fiber combined with a polymetric material. The composite fiber jacket can alternately include a material that is carbon fiber, Kevlar™, Vectran™, resin, epoxy, PEEK, and combinations thereof. An outer diameter of the composite fiber jacket can be in a range of 0.5-2.5 inches. The power cable can have a load capacity in a range of 20,000 to 40,000 lbf. The number of the at least two conductors can be not greater than three conductors.

### BRIEF DESCRIPTION OF THE DRAWINGS

So that the manner in which the above-recited features, aspects and advantages of the embodiments of this disclosure, as well as others that will become apparent, are attained and can be understood in detail, a more particular description of the disclosure briefly summarized above may be had by reference to the embodiments thereof that are illustrated in the drawings that form a part of this specification. It is to be noted, however, that the appended drawings illustrate only preferred embodiments of the disclosure and are, therefore, not to be considered limiting of the disclosure's scope, for the disclosure may admit to other equally effective embodiments.

FIG. 1 is a schematic section view of a subterranean well with an artificial lift system and power cable, in accordance with an embodiment of this disclosure.

FIG. 2 is a schematic cross section view of a power cable, in accordance with an embodiment of this disclosure.

### DETAILED DESCRIPTION

Embodiments of the present disclosure will now be described more fully hereinafter with reference to the accompanying drawings which illustrate embodiments of the disclosure. Systems and methods of this disclosure may, however, be embodied in many different forms and should not be construed as limited to the illustrated embodiments set forth herein. Rather, these embodiments are provided so that this disclosure will be thorough and complete, and will fully convey the scope of the disclosure to those skilled in the art. Like numbers refer to like elements throughout, and the prime notation, if used, indicates similar elements in alternative embodiments or positions.

In the following discussion, numerous specific details are set forth to provide a thorough understanding of the present disclosure. However, it will be obvious to those skilled in the art that embodiments of the present disclosure can be practiced without such specific details. Additionally, for the most part, details concerning well drilling, reservoir testing, well completion and the like have been omitted inasmuch as such details are not considered necessary to obtain a complete understanding of the present disclosure, and are considered to be within the skills of persons skilled in the relevant art.

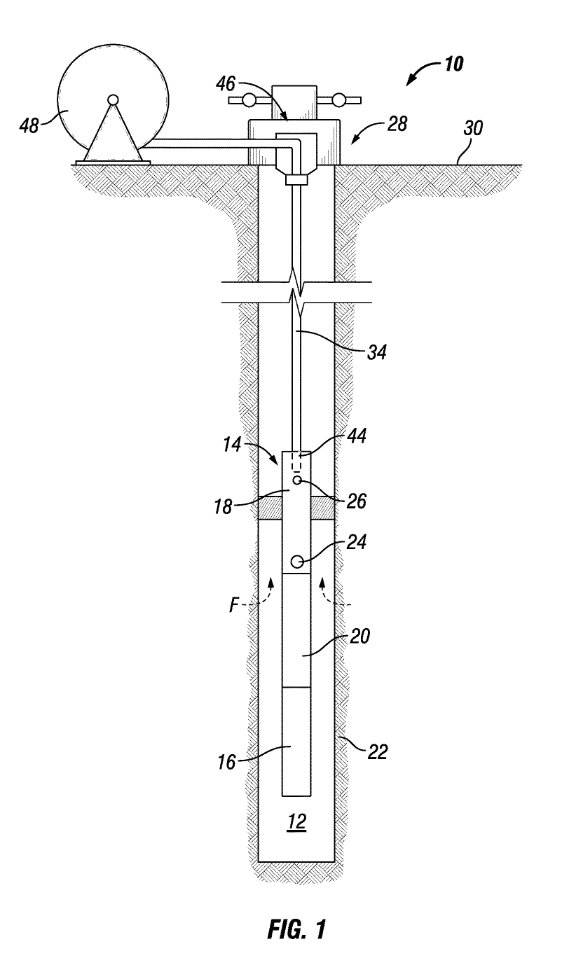

Looking at FIG. 1, subterranean well 10 includes wellbore 12. Artificial lift system 14 is located within wellbore 12. Artificial lift system 14 of FIG. 1 can be, for example, an electric submersible pump (ESP) system and includes a motor 16 on its lowermost end which is used to drive a pump 18 at an upper portion. Motor 16 can be, for example, an AC or DC induction motor or permanent magnet motor. Between motor 16 and pump 18 is seal section 20 for equalizing pressure within artificial lift system 14 with that of wellbore 12. Fluid F is shown entering wellbore 12 from a formation 22 adjacent wellbore 12. Fluid F flows to inlet 24 formed in the housing of pump 18. Fluid F is pressurized within pump 18 and exits out of artificial lift system 14 at outlet 26 and into wellbore 12 or a production string (not shown). Fluids would then travel up to wellhead 28 at surface 30. Packer 32 can seal around artificial lift system 14 between inlet 24 and outlet 26.

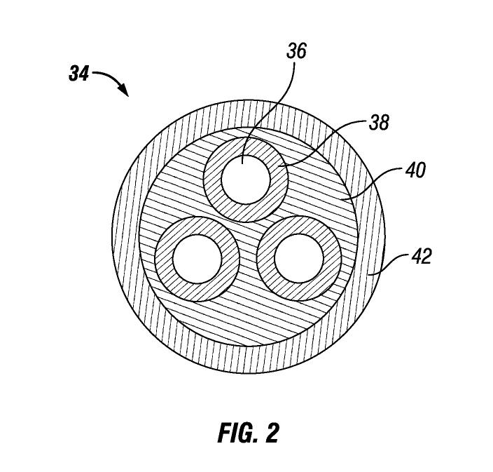

Artificial lift system 14 is suspended within wellbore 12 with power cable 34. Power cable 34 is an elongated member that extends from wellhead 28 to artificial lift system 14. Looking at FIG. 2, power cable 34 includes at least two conductors 36. Conductors 36 can be used to transmit electric power to artificial lift system 14.

Conductor 36 can be copper, aluminum, or other known material used to transmit electric power. Conductor 36 can be solid or stranded wires. In certain embodiments, conductor 36 is solid so that conductor 36 is more compact, permits more reliable splicing operations and better prevents gas migration compared to a stranded conductor 36. The size of conductor 36 can be, for example, AWG #1, 2, 4 or 6, depending on application. Conductor 36 can be round, as shown, or can be of another shape that optimizes the size of power cable 34.

In certain embodiments, there are two conductors 36 and in alternate embodiments there are three conductors 36. With two conductors 36, direct current can be transmitted artificial lift system 14 to drive a DC motor. In another configuration, downhole electronics can be deployed to convert DC to AV and a three-phase AC motor can be used to power artificial lift system 14. When three conductors 36 are included in power cable 34, 3-phase AC can be supplied directly to a motor of artificial lift system 14. In addition to conductors 36, power cable 34 can also include additional communication cables of either electrical wire or fiber optical cable for data transmission, or can include a conduit for fluid injection (not shown).

Conductors 36 are insulated conductors that are surrounded by insulating material 38. Insulating material 38 prevents short circuits and current leakage between conductors 36. Insulating material 38 must be able to withstand the high operating temperatures in wellbore 12, do not swell with hydrocarbon, and resist to the migration of free gas into the body of conductor 36. Commonly used insulating materials include polypropylene, ethylene propylene diene monomer (EPDM), and Nitrile rubbers. Polypropylene is a thermoplastic material, and can be used up to a temperature of around 200 F. EPDM is a thermosetting plastic material can be used at operating temperatures of 400 F and above. Supplementary protective layers (not shown) can be applied over insulating material 38. The types of protective layers can include tapes, braids, extruded barrier, laser welded metal tubes, and others known in the art.

In certain embodiments, conductors 36 can be encased with filler material 40. In alternate embodiments, no filler material 40 is used. Filler material 40 can protect conductor 36 and insulating material 38 from mechanical damage, and can fill the space between conductors 36. Filler material can be, for example, nitrile rubber, ethylene propylene diene monomer (EPDM), or other known filler material.

Conductors 36 are surrounded with composite fiber jacket 42 to an outermost member of power cable 34. Composite fiber jacket 42 has a substantially smooth exterior surface. In this context, the term substantially smooth means that it is a sufficiently continuous surface to provide a sealing surface for well control equipment. For example, a stripper can seal around the exterior surface of composite fiber jacket 42 for fluid containment. The substantially smooth surface can be rounded and is strong enough to allow operations with a coiled tubing injector head. A blow out preventer (BOP) can be used to shear, seal, and pipe ram to ensure well integrity under various pressure conditions. Composite fiber jacket 42 can effectively protect the whole power cable 34 from oil and decompression swelling. Composite fiber jacket 42 will be applied directly to filler material 38 and in embodiments where there is no filler material, to insulating material of conductors 36.

Fiber material choices for composite fiber jacket 42 will depend on the operating temperatures in downhole environment. The fiber material will have a lesser weight than load bearing wire members, such as contra-helical wire or armor wire, of some current systems. As an example, carbon fiber is a material consisting of fibers about 5-10 micrometers in diameter and composed mostly of carbon atoms. To produce carbon fiber, the carbon atoms are bonded together in crystals that are more or less aligned parallel to the long axis of the fiber as the crystal alignment gives the fiber high strength-to-volume ratio (making it strong for its size). Carbon fibers have desirable characteristics such as high stiffness, high tensile strength, low weight, high chemical resistance, high temperature tolerance and low thermal expansion.

Carbon fibers can be combined with other materials to form a composite. When combined with a plastic resin and wound or molded the combination forms carbon-fiber-reinforced polymer (often referred to as carbon fiber) which has a very high strength-to-weight ratio, is thermal stable at high temperatures, has a high strength and modulus, a low creep, and a good chemical stability. As an example, composite fiber jacket 42 can be made of carbon fiber, Kevlar™, Vectran™ or other synthetic fiber combined with resin, epoxy, polyether ether ketone (PEEK) or other polymeric materials.

Composite fiber jacket 42 acts as strength member and is both lighter and stronger than steel. Composite fiber jacket 42 can have a dimension of 1/10^{th} that of carbon steel, with two to three times the tensile strength of carbon steel. Composite fiber jacket 42 is also resistant to CO2, H2S, and other common corrosive oilfield fluids. Composite fiber jacket 42 can be applied by pultrusion, overextrusion, tape winding and sintering, or other methods known to those with the skill of the art.

Composite fiber jacket 42 is the load bearing member of the power cable 34. Composite fiber jacket 42 tightly surrounds the filler material 40 (if any) and conductors 36 so that the weight of filler material 40 and conductors 36 is transferred to composite fiber jacket 42. Composite fiber jacket 42 is formed tightly as an outer layer of power cable 34 so that there is no void to allow gas trapping or migration within an inner diameter of composite fiber jacket 42. As the outermost layer of power cable 34, composite fiber jacket 42 is free of an additional outer protective or strength layer.

Power cable 34 will have sufficient load capacity to hold its own weight plus the weight of artificial lift system 14, in addition to a designated over pull force. As an example, a required load capacity of the power cable 34 can be between 20,000-40,000 lbf, depending on the particular application. The thickness of composite fiber jacket 42 will be determined based on the selection of material used to form composite fiber jacket 42. The overall outside diameter of power cable 34 can be, for example, in the range of 0.5-2.5 inches. Providing a power cable 34 with a minimum outside diameter will result in a larger flow area for fluids being produced through wellbore 12.

An end of power cable 34 can be secured to artificial lift system 14 with connecting member 44. Connecting member 44 secures artificial lift system 14 to composite fiber jacket 42 of power cable 34 such that a load of artificial lift system 14 is transferred to, and supported by, composite fiber jacket 42 of power cable 34. Because of the simplicity of design of power cable 34, which can include two or three conductors 36, the connection of conductors 36 and composite fiber jacket 42 to artificial lift system 14 through connecting member 44 is relatively straight forward and reliable.

At an opposite end of power cable 34, power cable 34 is suspended from wellhead 28 with cable hanger 46. Cable hanger 46 allows for the weight of power cable 34 and artificial lift system 14 to be transferred through composite fiber jacket 42 to wellhead 28.

Power cable 34 can be stored at surface 30 in lengths on transportable reel 48 of workable size. As an example, power cable 34 can be provided in 6000-8,000 foot lengths on a spool of transportable reel 48. Composite fiber jacket 42 is sufficiently flexible to ensure that power cable can be spooled on conventional transportable reel 48 without delamination or cracking so that the integrity of composite fiber jacket 42 is retained when power cable 34 is deployed from the spool. Artificial lift system 14 is lowered into wellbore 12 with power cable 34 as power cable 34 is deployed from the spool of transportable reel 48.

In an example of operation, to provide power to artificial lift system 14 and both deploy and retrieve artificial lift system 14 in a rig-less operation, power cable 34 can be utilized, power cable 34 having the features described herein. Artificial lift system 14 is connected to power cable 34 and power cable 34 is used to lower artificial lift system 14 into wellbore 12. Artificial lift system 14 can be energized to assist in lifting fluids within wellbore 12 from a subterranean formation to surface 30. Artificial lift system 14 will be suspended from wellhead 28 by composite fiber jacket 42 so that composite fiber jacket 42 supports the weight of power cable 34 and artificial lift system 14. Artificial lift system 14 can further be retrieved from wellbore 12 with power cable 34.

Embodiments of the disclosure described herein, therefore, are well adapted to carry out the objects and attain the ends and advantages mentioned, as well as others inherent therein. While a presently preferred embodiment of the disclosure has been given for purposes of disclosure, numerous changes exist in the details of procedures for accomplishing the desired results. These and other similar modifications will readily suggest themselves to those skilled in the art, and are intended to be encompassed within the spirit of the present disclosure and the scope of the appended claims.

What is claimed is:

1. A method for providing power to an artificial lift system, the method comprising:
providing at least two conductors, each conductor being an insulated conductor having insulating material surrounding such conductor;
surrounding the at least two conductors with a composite fiber jacket to form a power cable, the composite fiber jacket being an outermost member of the power cable and having a substantially smooth exterior surface; and
connecting the power cable to the artificial lift system such that a load of the artificial lift system is transferred to the composite fiber jacket of the power cable.

2. The method of claim 1, further comprising before surrounding the at least two conductors with the composite fiber jacket, encasing the at least two conductors with a filler material.

3. The method of claim 2, wherein surrounding the at least two conductors with the composite fiber jacket includes applying the composite fiber jacket directly to the filler material.

4. The method of claim 1, wherein the composite fiber jacket is a flexible member, the method further comprising deploying the power cable from a spool to lower the artificial lift system into a wellbore.

5. The method of claim 1, wherein the power cable supports the load of the artificial lift system in a range of 20,000 to 40,000 lbf.

6. The method of claim 1, wherein surrounding the at least two conductors with the composite fiber jacket includes surrounding the at least two conductors with the composite fiber jacket that includes a synthetic fiber combined with a polymetric material.

7. The method of claim 1, wherein surrounding the at least two conductors with the composite fiber jacket includes surrounding the at least two conductors with the composite fiber jacket that includes a material selected from a group consisting of carbon fiber, Kevlar™, Vectran™, resin, epoxy, PEEK, and combinations thereof.

8. A method for providing power to an artificial lift system for producing fluids from or injecting fluids to a subterranean well, the method comprising:
providing at least two conductors, each conductor being an insulated conductor having insulating material surrounding such conductor;
surrounding the at least two conductors with a composite fiber jacket to form a power cable, the composite fiber jacket being an outermost member of the power cable and having a substantially smooth exterior surface;
connecting the power cable to the artificial lift system such that a load of the artificial lift system is transferred to the composite fiber jacket of the power cable;
lowering the artificial lift system into a wellbore with the power cable;
energizing the artificial lift system with the power cable to assist fluids within the subterranean well in being one of produced to a surface or injected downhole to a subterranean formation.

9. The method of claim 8, further comprising before surrounding the at least two conductors with the composite fiber jacket, encasing the at least two conductors with a filler material, and wherein surrounding the at least two conductors with the composite fiber jacket includes applying the composite fiber jacket directly to the filler material.

10. The method of claim 8, wherein the composite fiber jacket is a flexible member and lowering the artificial lift system into the wellbore with the power cable includes deploying the power cable from a spool.

11. The method of claim 8, further comprising supporting the artificial lift system within the wellbore such that the composite fiber jacket supports the load of the artificial lift system in a range of 20,000 to 40,000 lbf.

12. The method of claim 8, further comprising retrieving the artificial lift system from the wellbore with the power cable.

13. A system for providing power to an artificial lift system, the system comprising:
a power cable having at least two conductors, each conductor being an insulated conductor having insulating material surrounding such conductor;
a filler material encasing the at least two conductors; and
a composite fiber jacket surrounding the filler material, the composite fiber jacket being an outermost member of the power cable and having a substantially smooth exterior surface.

14. The system of claim 13, further comprising a connecting member, the connecting member securing an end of the power cable to the artificial lift system.

15. The system of claim 14, wherein the connecting member is oriented to transfer a load of the artificial lift system to the composite fiber jacket of the power cable.

16. The system of claim 13, wherein the composite fiber jacket is a flexible member operable to retain an integrity of the composite fiber jacket when deployed from a spool.

17. The system of claim 13, wherein the composite fiber jacket includes a synthetic fiber combined with a polymetric material.

18. The system of claim 13, wherein the composite fiber jacket includes a material selected from a group consisting of carbon fiber, Kevlar™, Vectran™, resin, epoxy, PEEK, and combinations thereof.

19. The system of claim 13, wherein an outer diameter of the composite fiber jacket is in a range of 0.5-2.5 inches.

20. The system of claim 13, wherein the power cable has a load capacity in a range of 20,000 to 40,000 lbf.

21. The system of claim 13, wherein the number of the at least two conductors is not greater than three conductors.
